(19) United States
(12) Patent Application Publication
(10) Pub. No.: US 2008/0299983 A1
(43) Pub. Date: Dec. 4, 2008

(54) Apparatus and Method For Measuring Carrier-To-Interference-and-Noise Ratio Using Downlink Preamble

(75) Inventors: Ki Young Kwak, Gyeonggi (KR); Kang Min Lee, Gyeonggi (KR); Ji Myung Oh, Gyeonggi (KR)

Correspondence Address: BLANK ROME LLP, 600 NEW HAMPSHIRE AVENUE, N.W., WASHINGTON, DC, 20037, US

(73) Assignee: Posdata Co., Ltd.

(21) Appl. No.: 12/159,689

(22) PCT Filed: Dec. 27, 2006
(86) PCT No.: PCT/KR2006/005761

§ 371 Date: Jun. 30, 2008

(30) Foreign Application Priority Data
Dec. 31, 2005 (KR) 10-2005-0136248

(51) Int. Cl. H04Q 7/20

(52) U.S. Cl. 455/446

(57) ABSTRACT

Provided are an apparatus and method for measuring a carrier-to-interference-and-noise ratio (CINR) using a downlink preamble in a digital communication system. More particularly, provided are an apparatus and method that measure CINRs using preambles of received signals respectively corresponding to a plurality of cells or sectors and perform handover and reverse power control using the CINRs in a digital communication system employing an orthogonal frequency division multiplexing (OFDM) technique or orthogonal frequency division multiple access (OFDMA) technique. According to the apparatus and method, it is possible to easily measure CINRs and perform handover and reverse power control using the measured CINRs. Therefore, deterioration in performance can be reduced even in a poor channel environment by maintaining a CINR received by a base station at an appropriate level.

### TECHNICAL FIELD

The present invention relates to an apparatus and method for measuring a carrier-to-interference-and-noise ratio (CINR) using a downlink preamble in a digital communication system. More particularly, the present invention relates to an apparatus and method that measure CINRs using preambles of received signals respectively corresponding to a plurality of cells or sectors and perform handover and reverse power control using the CINRs in a digital communication system employing an orthogonal frequency division multiplexing (OFDM) technique or orthogonal frequency division multiple access (OFDMA) technique.

### BACKGROUND ART

When a signal is transmitted through a multi-path channel, inter-symbol interference (ISI) due to multipaths occurs in the received signal. In order to reduce signal distortion caused by ISI, a symbol period must be longer than a channel delay spread. As a modulation method capable of simply compensating for such distortion occurring in a multipath channel, an orthogonal frequency division multiplexing (OFDM) technique (or an orthogonal frequency division multiple access (OFDMA) technique) has been suggested. Unlike a transmission technique using a single carrier, the OFDM technique transfers data using a plurality of mutually orthogonal sub-carriers. More specifically, the OFDM technique performs serial-parallel conversion for input data as many times as the number of sub-carriers used for modulation and modulates each converted data using the corresponding sub-carrier, thereby increasing the symbol period of each sub-carrier by the number of sub-carriers while maintaining a data transfer rate as is. Since the OFDM technique uses mutually orthogonal sub-carriers, it has better bandwidth efficiency and a longer symbol period than a conventional frequency division multiplexing (FDM) technique. Thus, the OFDM technique is more robust ISI than a single carrier modulation technique.

In an OFDM system, a transceiver unit performs a modulation/demodulation process of inverse discrete Fourier transform (IDFT) and discrete Fourier transform (DFT), which can be efficiently implemented by inverse fast Fourier transform (IFFT) and fast Fourier transform (FFT). Here, when a longer guard interval than a channel delay spread is inserted into each transmission symbol period, sub-carrier orthogonality is maintained.

In the above-described OFDM system, accurate measurement of channel signal quality is of utmost importance for power control or modulation/demodulation. A carrier-to-interference-and-noise ratio (CINR) is an example of a quantity used to gauge channel signal quality, and is used to control power and adjust modulation and coding scheme (MCS) according to channel quality in an apparatus for adaptive power control or adaptive modulation and coding scheme (MCS). Here, the CINR is defined as total sub-carrier signal power divided by total interference and noise power, and can be a reference for determining channel quality in the OFDM system.

Meanwhile, in today's cellular mobile communication environment, handover means a process of automatically changing a current communication channel for an other communication channel when a mobile terminal is moved from a sector to another sector within a cell or from a cell to another cell, and thus is necessary to ensure the terminal's mobility. For handover and other reasons, a base station managing each cell or sector needs to constantly check the state of a channel with a terminal. In addition, the terminal itself needs to maintain a good channel state by checking the quality of the channel with the base station.

In the present invention, a new technique is suggested that enables more easy and accurate measurement of a CINR using a preamble of a received signal in a digital communication system, and efficient utilization of the CINR for various purposes such as handover, and so on.

### DISCLOSURE OF INVENTION

### Technical Problem

The present invention is directed to more easily and accurately measuring a carrier-to-interference-and-noise ratio (CINR) of a received signal using a preamble.

The present invention is also directed to more accurately estimating a preamble signal from a preamble symbol by an interpolation operation and an averaging operation.

The present invention is also directed to measuring and comparing CINRs respectively corresponding to a plurality of cells or sectors and thereby performing handover for ensuring the mobility of a user terminal.

The present invention is also directed to selectively extracting interference and noise component signals according to a frequency reuse factor and thereby measuring a more accurate CINR.

The present invention is also directed to controlling the transmission power of a communication terminal using a measured CINR, so that the intensity of a signal received at a base station can be maintained at a proper level.

The present invention is also directed to reporting a CINR measured by a communication terminal to a base station, so that the base station can recognize channel state, etc. of the communication terminal and use them for scheduling.

### Technical Solution

One aspect of the present invention provides an apparatus for measuring a carrier-to-interference-and-noise ratio (CINR), comprising: a preamble symbol obtaining unit for obtaining preamble symbols respectively corresponding to a plurality of cells or sectors from a baseband frequency signal; a signal estimation unit for estimating a preamble signal and a data signal from each preamble symbol; a power calculation unit for, with respect to each cell or sector, calculating a power value of the estimated data signal and a power value of a noise signal from the preamble symbol and the estimated preamble signal; a CINR calculation unit for, with respect to each cell or sector, calculating a CINR using the power values of the data signal and the noise signal; and a handover determination unit for comparing the CINRs with each other and determining whether to perform handover or not.

Another aspect of the present invention provides a method of measuring a CINR using a preamble, comprising the steps of: obtaining preamble symbols respectively corresponding to a plurality of cells or sectors from a baseband frequency; estimating a preamble signal and a data signal from each preamble symbol; with respect to each cell or sector, calculating a power value of the estimated data signal and a power value of a noise signal from the preamble symbol and the estimated preamble signal; with respect to each cell or sector, calculating a CINR using the power values of the data signal and the noise signal; and comparing the CINRs with each other and determining whether to perform handover or not.

### ADVANTAGEOUS EFFECTS

According to the present invention, a carrier-to-interference-and-noise ratio (CINR) of a received signal can be measured more easily and accurately using a preamble.

In addition, according to the present invention, a preamble signal can be estimated from a preamble symbol more efficiently by an interpolation operation and an averaging operation.

In addition, according to the present invention, CINRs respectively corresponding to a plurality of cells or sectors are measured and compared with each other to perform handover, so that a seamless communication service can be maintained during movement.

In addition, according to the present invention, noise and interference component signals are selectively extracted according to a frequency reuse factor, so that a CINR can be measured more accurately.

In addition, according to the present invention, a base station controls the transmission power of a communication terminal using a CINR and thereby can properly adjust the intensity of a signal received from the communication terminal.

In addition, according to the present invention, the optimum transmission power adapted to a varying communication environment is generated using a measured CINR, so that communication quality can be further improved.

In addition, according to the present invention, a CINR measured by a communication terminal is reported to a base station, so that the base station can recognize the channel state of the communication terminal and properly cope with deterioration in channel quality.

### BRIEF DESCRIPTION OF THE DRAWINGS

FIG. 1 is a block diagram showing a constitution of a general orthogonal frequency division multiplexing (OFDM) transceiver;

FIG. 2 illustrates preamble structure according to segment in an exemplary embodiment of the present invention;

FIG. 3 is a block diagram illustrating apparatuses for measuring carrier-to-interference-and-noise ratios (CINRs) in a plurality of cells or sectors according to an exemplary embodiment of the present invention;

FIG. 4 is a block diagram showing a constitution of a CINR measuring apparatus determining whether to perform handover or not according to an exemplary embodiment of the present invention;

FIG. 5 is a block diagram showing a constitution of a CINR measuring apparatus controlling transmission power according to an exemplary embodiment of the present invention;

FIG. 6 is a block diagram showing a constitution of a CINR measuring apparatus reporting a CINR according to an exemplary embodiment of the present invention;

FIG. 7 is a block diagram showing a constitution of a signal estimation unit according to an exemplary embodiment of the present invention;

FIG. 8 is a block diagram showing a constitution of a power calculation unit according to an exemplary embodiment of the present invention;

FIG. 9 is a block diagram showing a constitution of a power calculation unit based on preamble according to an exemplary embodiment of the present invention;

FIG. 10 is a block diagram showing a constitution of a CINR calculation unit according to an exemplary embodiment of the present invention;

FIG. 11 is a flowchart showing a method of measuring CINRs in a plurality of cells or sectors using preambles according to an exemplary embodiment of the present invention;

FIG. 12 is a flowchart showing a method of measuring a CNIR using a preamble in a cell provided with a service according to an exemplary embodiment of the present invention; and

FIG. 13 illustrates graphs showing simulation results measuring CINRs using preambles according to an exemplary embodiment of the present invention.

### DESCRIPTION OF MAJOR SYMBOL IN THE ABOVE FIGURES

401: Preamble symbol obtaining unit
402: Signal estimation unit
403: Power calculation unit
404: CINR calculation unit
405: Handover determination unit

### MODE FOR THE INVENTION

In this specification, the terminology “communication terminal” refers to a portable electric/electronic device, including all kinds of handheld wireless communication devices, equipment having communication functions, portable terminals, and international mobile telecommunication (IMT)-2000 terminals. The equipment having communication functions includes personal digital cellular (PDC) phones, personal communication service (PCS) phones, code division multiple access (CDMA)-2000 (1× and 3×) phones, wideband CDMA (WCDMA) phones, dual band/dual mode phones, global standard for mobile (GSM) phones, mobile broadband system (MBS) phones, digital multimedia broadcasting (DMB) terminals, smart phones, orthogonal frequency division multiplexing (OFDM)/orthogonal frequency division multiple access (OFDMA) communication terminals, and so on. The portable terminals include personal digital assistants (PDAs), hand-held personal computers (PCs), notebook computers, laptop computers, wireless broadband Internet (WiBro) terminals, moving picture experts group layer 3 (MP3) players, and so on. And, the IMT-2000 terminals provide an international roaming service and an expanded mobile communication service. A communication terminal may have a predetermined communication module such as an OFDMA module, a CDMA module, a Bluetooth module, an infrared communication module, a wired/wireless local area network (LAN) card, and a wireless communication device equipped with a global positioning system (GPS) chip to enable positioning using a GPS system. Also, a communication terminal is equipped with a microprocessor capable of playing multimedia, thereby performing a specific operation.

In addition, the terminology “noise” (or “noise signal”) includes interference between channels occurring when frequency bands overlap each other and signals are mixed with each other as well as non-intended abnormal noise generated in a wireless communication environment. Noise includes not only a data signal intended to be transmitted but also all other signals included during a transmitting/receiving process. Therefore, in the present invention, “noise” and “noise and interference” may be considered as the same thing.

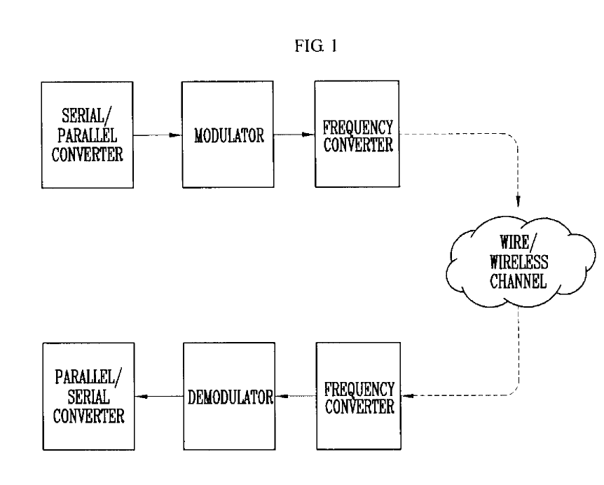

Hereinafter, an apparatus and method for measuring a carrier-to-interference-and-noise ratio (CINR) using a downlink preamble (referred to as “preamble” below) according to exemplary embodiments of the present invention will be described in detail with reference to FIGS. 1 to 13. However, the present invention is not limited to the exemplary embodiments disclosed below, but can be implemented in various forms. Therefore, the present exemplary embodiments are provided for complete disclosure of the present invention and to fully convey the scope of the present invention to those of ordinary skill in the art.

FIG. 1 is a block diagram showing a constitution of a general orthogonal frequency division multiplexing (OFDM) transceiver. As illustrated in FIG. 1, the general OFDM transceiver includes a serial/parallel converter, a fast Fourier transform (FFT) device or inverse fast Fourier transform (IFFT) device, and a frequency converter.

The serial/parallel converter of a transmitting unit converts a data stream input in serial into parallel data streams numbering the same as sub-carriers, and the IFFT device performs an IFFT operation on each parallel data stream. The IFFT data is converted back into serial data and transmitted after frequency conversion. A receiving unit receives a signal transmitted through a wired/wireless channel, and outputs data after a demodulation process that is the reverse of a process performed by the transmitting unit.

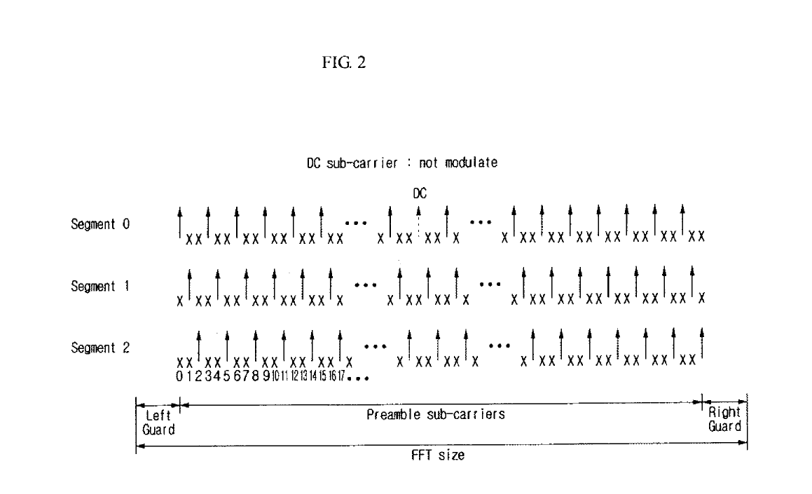

FIG. 2 illustrates preamble structure according to segment in an exemplary embodiment of the present invention. As illustrated in FIG. 2, guard bands for reducing interference from an adjacent frequency band are placed on the left and right of a plurality of sub-carriers, and a direct current (DC) sub-carrier, which is a null sub-carrier, is included. In addition, as illustrated in FIG. 2, every third sub-carrier is a preamble sub-carrier and may be used for initial synchronization, cell search, frequency offset and channel estimation.

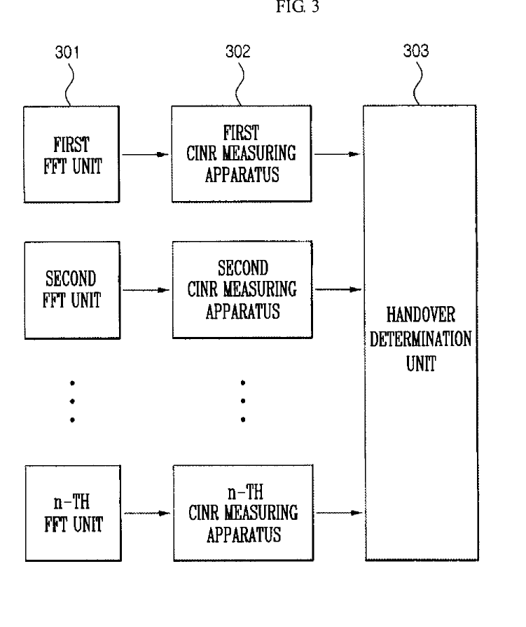

FIG. 3 is a block diagram illustrating apparatuses for measuring CINRs in a plurality of cells or sectors according to an exemplary embodiment of the present invention.

As illustrated in FIG. 3, CINR measuring apparatuses 302 respectively corresponding to a plurality of cells or sectors perform a predetermined preprocess of FFT on received baseband signals using FFT units 301 to transform the signals into the frequency domain signals.

A received signal transformed into the frequency domain includes a preamble signal that can be used for initial synchronization or cell search, a pilot signal used for channel and carrier frequency offset estimation, a data signal including actual data, noise components, and so on. In the present invention, a CINR is measured using the preamble signal.

In general, a preamble signal has a higher signal power level than a data signal and a pilot signal, and thus can be easily obtained even in a poor channel environment. Therefore, the present invention uses a preamble signal to measure a CINR, thereby improving accuracy.

In addition, according to the present invention, the FFT units 301 or the CINR measuring apparatuses 302 respectively corresponding to a plurality of cells or sectors may share one FFT unit 301 or one CINR measuring apparatus 302 by time division based on hardware. For example, when only one FFT unit 301 is used to transform received signals into the frequency domain, a predetermined time period is divided into a plurality of sufficiently small time intervals, and each time interval is periodically allocated to each received signal. Thus, the received signals may pass the FFT unit 301 without overlapping each other. In this way, one FFT unit 301 can easily transform signals respectively received from a plurality of cells or sectors into the frequency domain.

The CINR measuring apparatuses 302 of the present invention can be implemented in digital communication systems such as communication terminals, and the digital communication systems may be based on at least one of the Institute of Electrical and Electronics Engineers (IEEE) 802.16d/e standard, wireless broadband Internet (WiBro), and worldwide interoperability for microwave access (WiMAX).

Meanwhile, a handover determination unit 303 receives CINRs respectively corresponding to a plurality of cells or sectors from the CINR measuring apparatuses 302, compares them with each other, and performs handover to a cell or sector having a better communication environment. In other words, according to the present invention, it is possible to perform more positive and efficient handover on the basis of CINRs respectively measured for a plurality of cells or sectors.

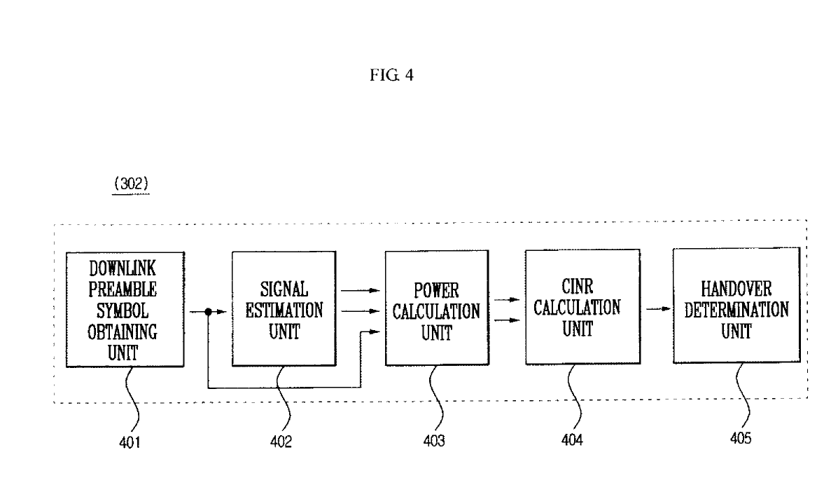

FIG. 4 is a block diagram showing a constitution of the CINR measuring apparatus 302 determining whether to perform handover or not according to an exemplary embodiment of the present invention.

As illustrated in FIG. 4, the CINR measuring apparatus 302 includes a preamble symbol obtaining unit 401, a signal estimation unit 402, a power calculation unit 403, a CINR calculation unit 404, and a handover determination unit 405.

The preamble symbol obtaining unit 401 obtains a preamble symbol (or preamble symbol signal) from a baseband frequency signal. As an example of the present invention, the preamble symbol obtaining unit 401 multiplies a preamble code by a plurality of sub-carriers of the baseband frequency signal, which is an OFDM/orthogonal frequency division multiple access (OFDMA) signal, or performs an exclusive OR (XOR) operation on them, thereby obtaining a preamble symbol to be used for measuring a CINR.

The transmission positions of preamble symbols have been regulated according to each channel mode, and preamble symbols have orthogonality. Therefore, preamble symbols can be easily extracted by multiplying sub-carriers of a received signal by a preamble sequence (code) having a regulated uniform pattern. A preamble code is a unique value determined for each cell or sector and is transmitted from a base station managing the cell or sector to a terminal.

For example, when a preamble signal having a previously set uniform pattern is modulated using binary phase shift keying (BPSK), a preamble sequence corresponds to 1 and −1 of a complex number because a transmission signal is made to correspond to two phases, i.e., 0 and π and transmitted by BPSK. Therefore, a desired preamble symbol can be obtained alone by calculating correlation between the preamble sequence and a received baseband signal.

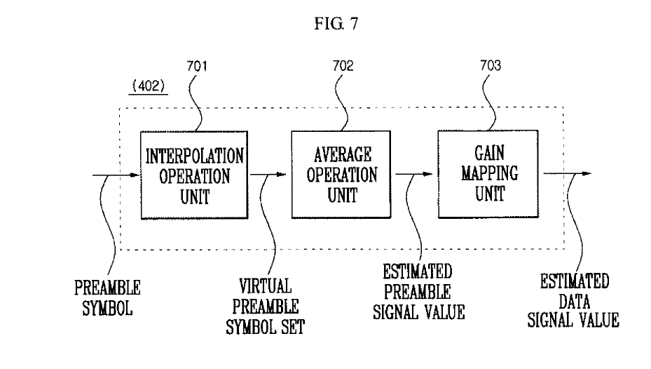

The signal estimation unit 402 estimates a preamble signal and a data signal from the preamble symbol obtained by the preamble symbol obtaining unit 401. Since the preamble signal and a noise and interference signal are mixed in the preamble symbol obtained by the preamble symbol obtaining unit 401, the signal estimation unit 402 estimates only the preamble signal from the preamble symbol and then estimates the noise and interference component signal on the basis of the preamble signal. In addition, the signal estimation unit 402 estimates the data signal on the basis of the estimated preamble signal value. Operation of the signal estimation unit 402 will be described in further detail below with reference to FIG. 7.

The power calculation unit 403 calculates a power value of the data signal estimated by the signal estimation unit 402 and calculates a power value of the noise signal using a difference between the preamble symbol obtained by the preamble symbol obtaining unit 401 and the preamble signal estimated by the signal estimation unit 402.

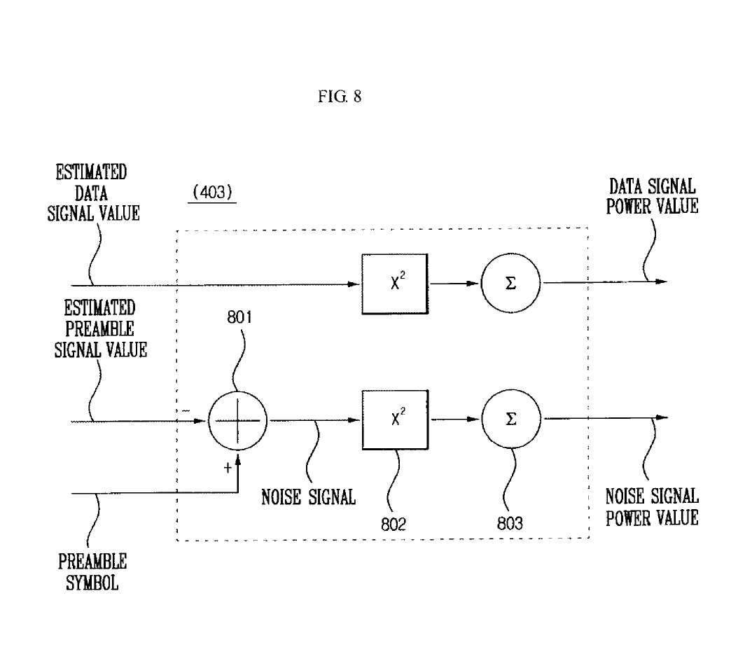

In other words, the power calculation unit 403 calculates the power values by squaring the data signal and the noise signal. In addition, with respect to a plurality of preamble symbols, the power calculation unit 403 separately accumulates power values of data signals and those of noise signals for a predetermined time, thereby further improving the accuracy of CINR calculation. Operation of the power calculation unit 403 will be described in further detail below with reference to FIG. 8.

The CINR calculation unit 404 calculates a CINR using the power values of the data signal and the noise signal calculated by the power calculation unit 403. A CINR is defined as total sub-carrier signal power divided by total interference and noise power. Therefore, the CINR calculation unit 404 can calculate the CINR by dividing the power value of the data signal by the power value of the noise signal.

$$CINR = \frac{G \cdot {\sum }_{n = 0}^{N - 1} {\vert \hat{h} ( n ) \vert}^{2}}{{\sum }_{n = 0}^{N - 1} {\vert p ( n ) - \hat{h} ( n ) \vert}^{2}} \qquad ( Formula 1 )$$

Formula 1 expresses the process of calculating a CINR using the power calculation unit 403 and the CINR calculation unit 404. Here,

ĥ
(n) denotes a preamble signal estimated according to the present invention, p(n) denotes a preamble symbol in which preamble signal components are mixed with noise components, N denotes an accumulation parameter of each terminal, and G denotes a parameter for adjusting a signal measured using a preamble symbol to the gain of a data signal.

In addition, n denotes a preamble symbol sub-carrier index, and N denotes the maximum preamble carrier index that can be determined based on power consumption and obtained from a downlink frame. In case of multiple zones, N denotes the maximum value that can be obtained from the corresponding zone. In other words, N is the number of preamble symbol sub-carriers.

According to another exemplary embodiment of the present invention, a plurality of CINRs respectively corresponding to a plurality of cells or sectors may be measured and used for handover.

More specifically, using a preamble code corresponding to each cell or sector, a preamble symbol obtaining unit 401 can obtain a preamble symbol of the cell or sector from a baseband frequency signal corresponding to the cell or sector.

In addition, a signal estimation unit 402 estimates preamble signals and data signals respectively corresponding to the preamble symbols obtained by the preamble symbol obtaining unit 401. Subsequently, with respect to each cell or sector, a power calculation unit 403 calculates a power value of a data signal estimated by the signal estimation unit 402 and a power value of a noise signal from a difference between a preamble symbol obtained by the preamble symbol obtaining unit 401 and a preamble signal estimated by the signal estimation unit 402.

In addition, a CINR calculation unit 404 calculates a CINR of each cell or sector using power values of a data signal and a noise signal calculated by the power calculation unit 403 according to the cell or sector.

The CINR measuring apparatus 302 of the present invention further includes a handover determination unit 405, which compares the CINRs measured according to cells or sectors with each other and determines whether to perform handover or not or performs handover.

The handover determination unit 405 compares CINRs measured according to cells or sectors with each other and performs handover to a cell or sector having a better CINR. In this way, it is possible to maintain seamless communication service during movement and perform more positive and efficient handover for improving a communication environment.

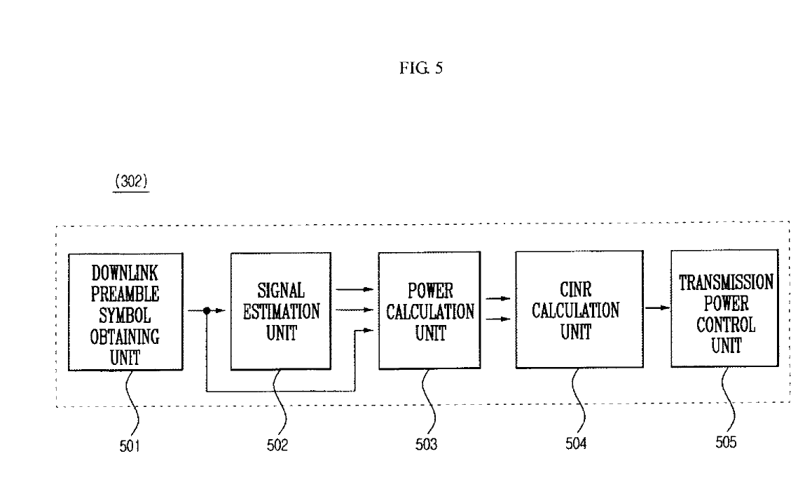

FIG. 5 is a block diagram showing a constitution of a CINR measuring apparatus controlling transmission power according to an exemplary embodiment of the present invention.

As illustrated in FIG. 5, the CINR measuring apparatus includes a preamble symbol obtaining unit 501, a signal estimation unit 502, a power calculation unit 503, a CINR calculation unit 504, and a transmission power control unit 505.

The preamble symbol obtaining unit 501, the signal estimation unit 502, the power calculation unit 503, and the CINR calculation unit 504 are the same as in the foregoing embodiments.

In addition, the CINR measuring apparatus of this exemplary embodiment further includes the transmission power control unit 505, which generates the optimum transmission power in varying communication environment on the basis of a CINR.

In general, signal attenuation increases when a terminal moves away from a base station, and decreases when the terminal moves toward the base station. Thus, power control is required for minimizing the influence of signal attenuation. The transmission power control unit 505 of the present invention uses a CINR as a reference for determination of signal attenuation and adjusts a transmission power level according to the signal attenuation.

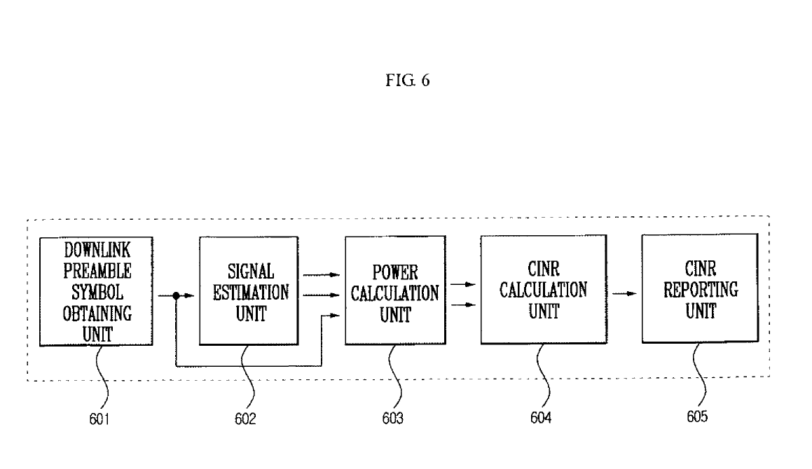

FIG. 6 is a block diagram showing a constitution of a CINR measuring apparatus reporting a CINR according to an exemplary embodiment of the present invention.

As illustrated in FIG. 6, the CINR measuring apparatus includes a preamble symbol obtaining unit 601, a signal estimation unit 602, a power calculation unit 603, a CINR calculation unit 604, and a CINR reporting unit 605.

The preamble symbol obtaining unit 601, the signal estimation unit 602, the power calculation unit 603, and the CINR calculation unit 604 are the same as in the foregoing embodiments illustrated in FIGS. 4 and 5.

The CINR reporting unit 605 transmits a CINR measured from a currently serving cell or sector to the corresponding base station. Then, the base station can schedule wireless resource factors for an efficient communication environment using the reported CINR.

The CINR reporting unit 605 converts the CINR into formats demanded by the base station, e.g., a decibel (dB) scale, a mean value, and a variance, and reports it to the base station, thereby allowing the base station to utilize the CINR.

The base station can adaptively change wireless resource factors, e.g., a modulation scheme, a coding scheme, a code type, a coding rate, etc., in consideration of the reported CINR. In addition, using the CINR, the base station can monitor a state of a backward channel to obtain error correction information, compare it with a predetermined value, and order a terminal to increase or decrease an output according to the result. By adjusting the power of the backward channel in this way, the base station can satisfy communication quality requirements and simultaneously maximize capacity.

FIG. 7 is a block diagram showing a constitution of the signal estimation unit 402 according to an exemplary embodiment of the present invention. As illustrated in FIG. 7, the signal estimation unit 402 includes an interpolation operation unit 701 and an average operation unit 702.

The interpolation operation unit 701 receives preamble symbols and performs an interpolation operation in the frequency domain, thereby generating a predetermined virtual preamble symbol set. According to the present invention, the amount of information, i.e., the number, of the preamble symbols obtained from the preamble symbol obtaining unit 401 is not sufficient for estimating a preamble signal or other purposes. Thus, a method is required for estimating the preamble signal more efficiently using the preamble symbol.

According to an example of the method, the interpolation operation unit 701 copies the preamble symbols to increase the number and calculates an intermediate value between the increased preamble symbols by a predetermined interpolation operation, thereby generating the virtual preamble symbol set appropriate for estimating the preamble signal.

The interpolation operation may use linear interpolation, secondary interpolation, cubic spline interpolation, interpolation with a low-pass filter, etc. The interpolation operation may be appropriately selected according to system requirements and accuracy.

The average operation unit 702 performs an averaging operation on the virtual preamble symbol set generated by the interpolation operation unit 701 in the time domain, thereby estimating the preamble signal. The virtual preamble symbol set includes noise and interference component signals as well as the preamble signals. The noise and interference component signals are kinds of white noise and have a random probability distribution in generation frequency and level. Therefore, when the average operation unit 702 sums up and averages all preamble symbols included in the virtual preamble symbol set in the time domain, all the noise and interference component signals are suppressed, and the desired preamble signal alone can be easily extracted.

In addition, a gain mapping unit 703 finally estimates a data signal using the preamble signals. In general, a preamble signal is different from a data signal in transmission power based on a channel structure or OFDMA/OFDM symbol structure. Therefore, in order to estimate the data signal from the preamble signals, the gain mapping unit 703 multiplies the estimated preamble signal by an appropriate weight, thereby adjusting the gain.

For example, when the level of the preamble signal is higher than the level of the data signal by a predetermined power measured in dB, the data signal can be estimated by properly mapping the gain so that the preamble signal level corresponds to the data signal level.

In this way, the signal estimation unit 402 can extract a data signal more accurately and easily by operation of the interpolation operation unit 701, the average operation unit 702, and the gain mapping unit 703.

FIG. 8 is a block diagram showing a constitution of the power calculation unit 403 according to an exemplary embodiment of the present invention. As illustrated in FIG. 8, the power calculation unit 403 receives an estimated data signal value, an estimated preamble signal value and a preamble symbol and outputs a data signal power value and a noise signal power value.

The power calculation unit 403 can extract a noise signal from a difference between a preamble symbol and an estimated preamble signal. More specifically, since the preamble symbol includes a preamble signal and a interference and noise signal, it is possible to extract the interference and noise signal alone by subtracting the estimated preamble signal from the preamble symbol (801). In addition, the power calculation unit 403 performs an accumulation operation (803) on the data signal and the noise signal for a predetermined time after a squaring operation (802), thereby calculating the data signal power value and the noise signal power value.

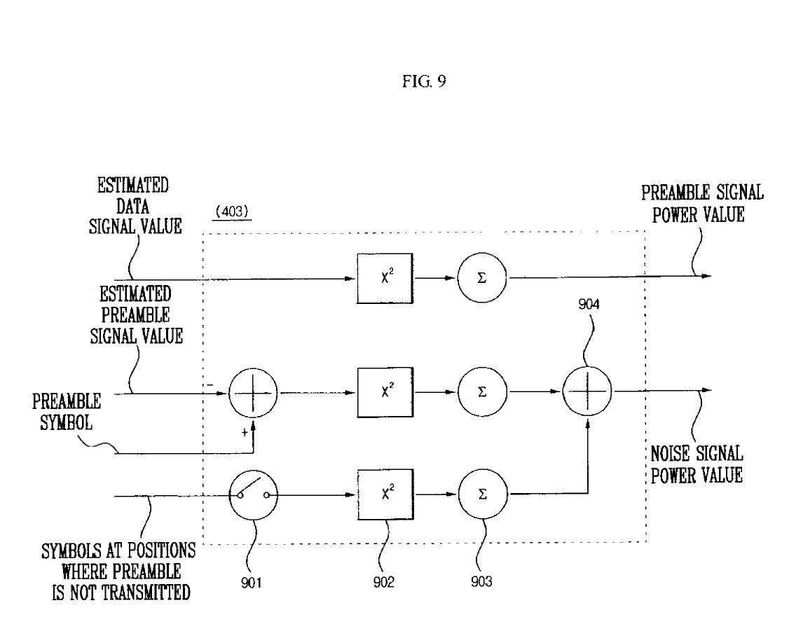

FIG. 9 is a block diagram showing a constitution of a power calculation unit depending on a frequency reuse factor according to an exemplary embodiment of the present invention.

The frequency reuse factor is a parameter indicating frequency efficiency, which means how many an entire frequency band is divided and allocated to. The frequency reuse factor is used in a method of increasing the number of channels per unit area.

In the present invention, different methods may be applied to calculate the power of noise and interference components according to the frequency reuse factor.

More specifically, when the frequency reuse factor is not 1, different frequency bands can be used in one cell or sector. Thus, in the structures of FIG. 2, noise and interference components only at positions where a preamble is transmitted should be considered.

On the other hand, when the frequency reuse factor is 1, the same frequency band can be used all over one cell or sector. Thus, in the structures of FIG. 2, symbol values at positions where a preamble is not transmitted include noise and interference components. Therefore, when the frequency reuse factor is 1, noise and interference factors must be considered in CINR calculation. In other words, according to the present invention, when the frequency reuse factor is 1, the power calculation unit further includes power values of symbols other than the preamble symbol in a power value of the noise signal.

As illustrated in FIG. 9, a selector 901 closes or opens a switch according to the frequency reuse factor, thereby performing the operation of adding or excluding symbol values at positions where a preamble is not transmitted as/from noise and interference components.

When the frequency reuse factor is 1, a CINR is calculated by Formula 2 given below.

$$CINR = \frac{G \cdot {\sum }_{n = 0}^{N - 1} {\vert \hat{h} ( n ) \vert}^{2}}{{\sum }_{n = 0}^{N - 1} {\vert p ( n ) - \hat{h} ( n ) \vert}^{2} + {\sum }_{m = 0}^{M - 1} {\vert p ( m ) \vert}^{2}} \\ Here , \hat{h} \qquad ( Formula 2 )$$

(n) denotes a preamble signal estimated according to the present invention, p(n) denotes a modulation downlink (DL) preamble symbol in which preamble signal components are mixed with noise components, p(m) denotes an un-modulation DL preamble symbol in which noise (including interference) components are mixed, and G denotes a parameter for adjusting a signal measured using preamble symbols to gain of a data signal. In addition, n denotes a preamble symbol sub-carrier index, N denotes the maximum preamble carrier index that can be determined based on power consumption and obtained from a downlink frame, and M denotes an accumulation parameter. In other words, N is the number of modulated preamble symbol sub-carriers, and M denotes the number of un-modulated preamble symbol sub-carriers. Meanwhile, p(m) excludes a left guard interval, a right guard interval, and a DC sub-carrier.

When Formula 2 is compared with Formula 1, Formula 2 further includes power values of the signal p(m) indicating symbol values at positions where a preamble is not transmitted in the denominator indicating the total power of noise and interference component signals. That is, when the frequency reuse factor is 1, power values of symbols other than preamble symbols are further included in the total power value of the noise signals.

In this way, according to the present invention, noise and interference component signals are extracted or not depending on the frequency reuse factor, so that a CINR can be measured more accurately.

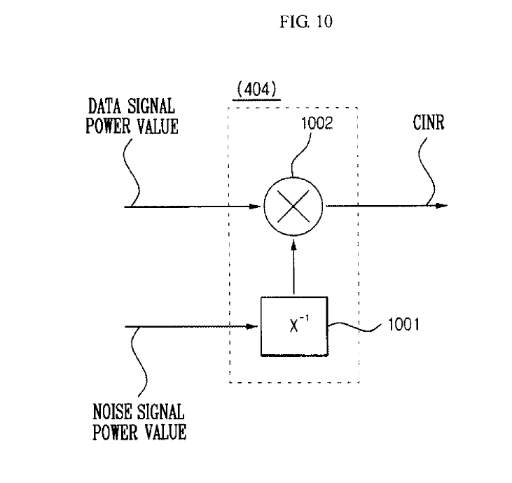

FIG. 10 is a block diagram showing a constitution of the CINR calculation unit 404 according to an exemplary embodiment of the present invention. A signal-to-noise ratio (SNR) is a ratio of a signal level to a noise level in a signal transmission system. In an OFDM/OFDMA system according to the present invention, a CINR can be measured as an example of the carrier signal-to-noise ratio. The CINR, which is generally expressed in units of dB, is defined as total sub-carrier signal power divided by total noise and interference power, and can be obtained using a power value of a data signal and a power value of a noise signal in the present invention.

In the CINR calculation unit 404, in order to calculate a CINR, the reciprocal of a noise signal power value is taken (1001) and input to a multiplier together with a data signal power value (1002).

Meanwhile, according to another exemplary embodiment of the present invention, a CINR measuring apparatus performing handover using a preamble and a frequency reuse factor includes a preamble obtaining unit, a signal estimation unit, a power calculation unit, a CINR calculation unit, and a handover determination unit. The preamble obtaining unit obtains preamble symbols respectively corresponding to a plurality of cells or sectors from a baseband frequency signal. The signal estimation unit estimates a preamble signal and a data signal from each preamble symbol. With respect to each cell or sector, the power calculation unit calculates a first power value of the estimated data signal and a second power value of a noise signal from the preamble symbol and the estimated preamble signal. With respect to each cell or sector, the CINR calculation unit calculates a CINR using the first and second power values. The handover determination unit compares the CINRs with each other and determines whether to perform handover or not. According to the frequency reuse factor, the power calculation unit determines whether or not to add third power values of symbols at positions where the preamble symbol is not transmitted to the second power values.

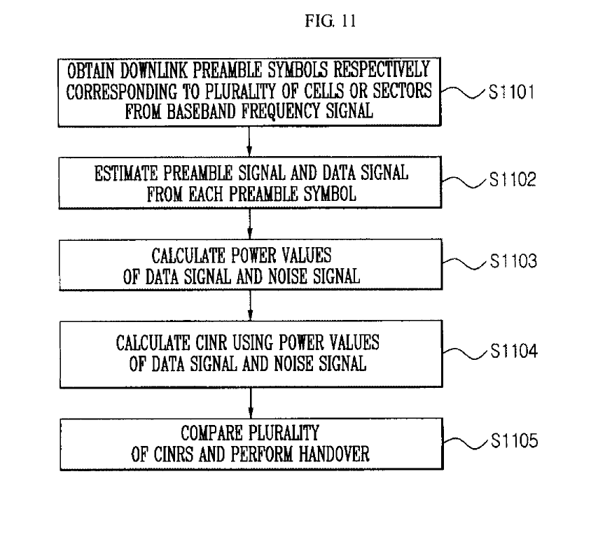

FIG. 11 is a flowchart showing a method of measuring CINRs respectively corresponding to a plurality of cells or sectors using preambles according to an exemplary embodiment of the present invention.

In step 1101, preamble symbols respectively corresponding to a plurality of cells or sectors are obtained from a baseband frequency signal.

According to an exemplary embodiment, in step 1101, a predetermined preamble code is multiplied by a plurality of sub-carriers of the baseband frequency signal, which is an OFDM/OFDMA signal, or an XOR operation is performed on them, so that preamble symbols to be used for measuring CINRs can be obtained.

The transmission positions of the preamble symbols have been regulated in advance according to each channel mode, and the preamble symbols have orthogonality. Therefore, the preamble symbols can be easily extracted by multiplying sub-carriers of a received signal by a preamble sequence (code) having a regulated uniform pattern.

In step 1102, a preamble signal and a data signal are estimated from each preamble symbol. Since preamble signals and noise and interference component signals are mixed in the preamble symbols obtained in step 1101, preamble signals are estimated from the preamble symbols in this step.

Step 1102 includes the sub-steps of performing the interpolation operation on the preamble symbols in the frequency domain to generate a virtual preamble symbol set, and performing the averaging operation on the virtual preamble symbol set in the time domain to estimate the preamble signals.

Since the amount of information, i.e., the number, of the preamble symbols obtained in step 1101 is generally not sufficient for estimating a preamble signal or other purposes, a method is required for estimating the preamble signals more efficiently using the preamble symbols.

For this reason, in the sub-step of generating a virtual preamble symbol set, the preamble symbols are input, copied and increased, and an intermediate value between the increased preamble symbols is calculated by a predetermined interpolation operation, thereby generating a virtual preamble symbol set appropriate for estimating the preamble signals.

The interpolation operation may use linear interpolation, secondary interpolation, cubic spline interpolation, interpolation with a low-pass filter, etc. The interpolation operation may be appropriately selected according to system requirements and accuracy.

In addition, in the sub-step of estimating the preamble signals, the averaging operation is performed on the virtual preamble symbol set in the time domain, thereby estimating the preamble signals. The virtual preamble symbol set includes noise and interference component signals as well as the preamble signals. The noise and interference component signals are kinds of white noise and have a random probability distribution in generation frequency and level. Therefore, in this step, when all preamble symbols included in the virtual preamble symbol set are summed and averaged in the time domain, all the noise and interference component signals are suppressed, and only desired preamble signals can be easily extracted.

In addition, in this step, in order to finally estimate data signals using the preamble signals, the estimated preamble signal values are multiplied by an appropriate weight, thereby adjusting the gain. For example, when levels of the preamble signals are higher than levels of the data signals by a predetermined power in units of dB, the data signals can be estimated by properly mapping the gain so that the preamble signal levels correspond to the data signal levels.

In step 1103, the estimated data signals and the preamble signals, and the preamble symbols are received, and power values of the data signals and noise signals are calculated. More specifically, in this step, with respect to each cell or sector, a power value of a data signal estimated in step 1102 is calculated, and a power value of a noise signal is calculated from an estimated preamble signal and a preamble symbol obtained in step 1101.

The preamble symbol includes a preamble signal and an interference and noise signal. Thus, the interference and noise signal alone can be extracted by subtracting the estimated preamble signal from the preamble symbol. Furthermore, in this step, the accumulation operation is performed on the estimated data signals and extracted noise signals for a predetermined time after the squaring operation, thereby calculating the data signal power values and the noise signal power values.

In addition, in this step, symbol values at positions where a preamble is not transmitted may be added or excluded as/from noise and interference components according to a frequency reuse factor, which is a parameter indicating how many an entire frequency band is divided and allocated to, i.e., indicating frequency efficiency.

For example, when the frequency reuse factor is 3, a different frequency band may be used in each cell. Thus, in the structures of FIG. 2, only noise and interference components at positions where a preamble is transmitted should be considered.

On the other hand, when the frequency reuse factor is 1, the same frequency band can be used in all the cells, and thus symbol values at positions where a preamble is not transmitted include noise and interference components in the structures of FIG. 2. Therefore, when the frequency reuse factor is 1, the noise and interference components must be considered in CINR calculation. In other words, according to the present invention, when the frequency reuse factor is 1, a power calculation unit further includes power values of symbols other than the preamble symbols in a power value of the noise signal.

In step 1104, with respect to each cell or sector, a CINR is calculated using a data signal power value and a noise signal power value calculated in step 1103. In other words, since a CINR is defined as total sub-carrier signal power divided by total interference and noise power, the CINR can be calculated by dividing the data signal power value by the noise signal power value in this step.

In step 1105, the CINRs measured according to the cells or sectors are compared with each other to determine whether to perform handover or not.

More specifically, in this step, the CINRs measured according to the cells or sectors are compared with each other, and handover is performed to a cell or sector having a better CINR. In this way, it is possible to maintain seamless communication service during movement and perform more positive and efficient handover for improving a communication environment.

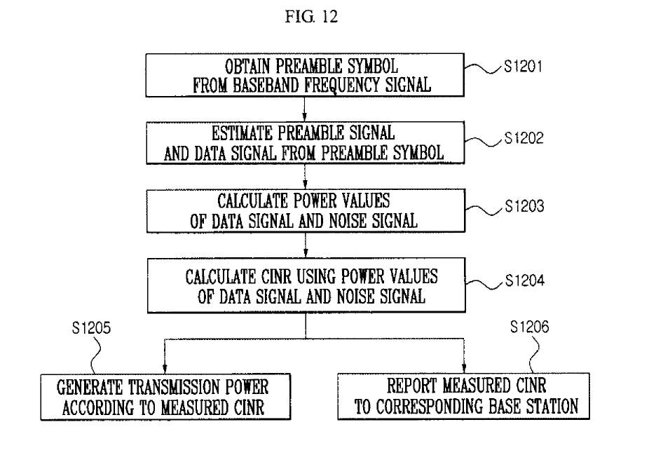

FIG. 12 is a flowchart showing a method of measuring a CNIR using a preamble in a cell provided with service according to an exemplary embodiment of the present invention.

In step 1201, a preamble symbol is obtained from a baseband frequency signal in a cell or sector currently provided with service. In this step, a predetermined preamble code of a corresponding base station is multiplied by a plurality of sub-carriers of the baseband frequency signal, which is an OFDM/OFDMA signal, or processed by an XOR operation together with the sub-carriers, so that the preamble symbol to be used for measuring a CINR can be obtained.

In step 1202, a preamble signal and a data signal are estimated from the preamble symbol. Since a preamble signal and a noise and interference component signal are mixed in the preamble symbol obtained in step 1201, the preamble signal alone is estimated from the preamble symbol in this step.

Step 1202 includes the sub-steps of performing the interpolation operation on the preamble symbol in the frequency domain to generate a virtual preamble symbol set, and performing the averaging operation on the virtual preamble symbol set in the time domain to estimate the preamble signal.

In the sub-step of generating a virtual preamble symbol set, the preamble symbol is input, copied and increased, and an intermediate value between the increased preamble symbols is calculated by a predetermined interpolation operation, thereby generating a virtual preamble symbol set appropriate for estimating the preamble signal.

In addition, in the sub-step of estimating the preamble signal, the averaging operation is performed on the virtual preamble symbol set in the time domain, thereby estimating the preamble signal. The virtual preamble symbol set includes noise and interference component signals as well as the preamble signal. The noise and interference component signals are kinds of white noise and have a random probability distribution in generation frequency and level. Therefore, in this step, when all preamble symbols included in the virtual preamble symbol set are summed and averaged in the time domain, all the noise and interference component signals are suppressed, and only a desired preamble signal can be easily extracted.

In addition, in this step, in order to finally estimate a data signal using the preamble signal, the estimated preamble signal value is multiplied by an appropriate weight, thereby adjusting the gain.

In step 1203, the estimated data signal and preamble signal, and the preamble symbol, are received, and power values of the data and noise signals are calculated. More specifically, in this step, a power value of the data signal estimated in step 1202 is calculated, and power values of the noise signals are calculated from the estimated preamble signal and the preamble symbol obtained in step 1201.

In addition, in this step, symbol values at positions where a preamble is not transmitted may be added or excluded as/from noise and interference components according to a frequency reuse factor, which is a parameter indicating how many an entire frequency band is divided and allocated to, i.e., indicating frequency efficiency.

In step 1204, a CINR is calculated using the data signal power value and noise signal power values calculated in step 1203. In other words, since a CINR is defined as total sub-carrier signal power divided by total interference and noise power, the CINR can be calculated by dividing the data signal power value by the total of the noise signal power values in this step.

In step 1205, efficient transmission power is generated according to the CINR measured by steps 1201 to 1204. In general, signal attenuation increases when a terminal moves away from a base station, and decreases when the terminal moves toward the base station. Thus, power control is required for offsetting signal attenuation. Consequently, in this step, a transmission power level is efficiently adjusted according to signal attenuation using the CINR as a reference for determination of signal attenuation.

In step 1206, the CINR measured by steps 1201 to 1204 is reported to a base station managing the cell or sector currently provided with a service through an uplink. In addition, the base station can schedule wireless resource factors for an efficient communication environment using the reported CINR.

In this step, the CINR is converted into a format required by the base station, e.g., a dB scale, a mean value, and a variance, and reported to the base station, thereby allowing the base station to utilize the CINR. In consideration of the reported CINR, the base station can adaptively change wireless resource factors, e.g., a modulation scheme, a coding scheme, a code type, a coding rate, etc.

Thus far, methods of measuring a CINR using a preamble have been described according to exemplary embodiments of the present invention. Descriptions of embodiments shown in FIGS. 1 to 10 can be applied to these embodiments without modification and thus will not be reiterated here.

The methods of measuring a CINR using a preamble according to exemplary embodiments of the present invention can be embodied as computer program commands and recorded on computer-readable media. The computer-readable media may include program commands, data files, data structures, etc. separately or compositely. The program commands recorded in the media may be particularly designed and configured for the present invention, or known and used by those skilled in the computer software field. The computer-readable media may be magnetic media such as a hard disk, a floppy disk and magnetic tape, optical media such as a compact disk read-only memory (CD-ROM), and hardware devices such as a ROM, a random-access memory (RAM), a flash memory, etc., particularly implemented to store and execute program commands. Also, the media may be transmission media such as optical or metal lines, waveguides, etc. including carriers delivering signals indicating program commands, data structures, and so on. The program commands may be machine language codes produced by a compiler and high-level language codes that can be executed by computers using an interpreter, etc. In order to perform the operations of the present invention, the hardware devices may be implemented to operate as at least one software module, and vice versa.

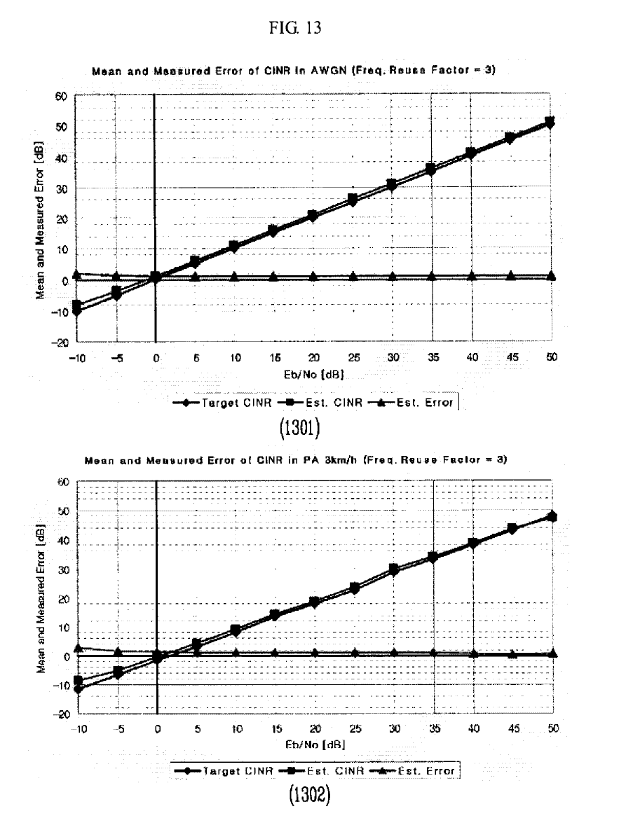

FIG. 13 illustrates graphs of CNIRs measured by simulation using preambles according to an exemplary embodiment of the present invention.

The simulation was performed when a frequency reuse factor was 3 under the additive white Gaussian noise (AWGN) condition and when the frequency reuse factor was 3 and a terminal was moving at 3 km/h according to the international telecommunication union radio communication sector (ITU-R) pedestrian-A channel model. The simulation employed 1024-point FIT, and the graphs show results obtained by averaging values measured 3 000 times.

Meanwhile, in FIG. 13, “Target CINR” denotes a desired CINR value, and “Est. CINR” denotes a result measured by employing an algorithm for measuring a CINR using a preamble according to the present invention. “Est. Error” denotes difference between “Target CINR” and “Est. CINR”, and indicates measurement error caused by the CINR measuring algorithm according to the present invention. In addition, the horizontal axis denotes signal power to noise power ratio per data bit (Eb/No [dB]), and the vertical axis denotes actually measured value and error value. Therefore, it is most preferable that a horizontal axis value and a vertical axis value are equal and the error becomes 0, or that errors have a uniform value and form a straight line.

As illustrated in FIG. 13, the experimental result under the AWGN condition 1301 and the experimental result obtained while the terminal was moving at 3 km/h according to the pedestrian-A channel model 1302 both show “Est. Error” values of almost 0 that are very small and nearly uniform. Consequently, the algorithm of the present invention shows excellent simulation results of CINR measurement.

While the invention has been shown and described with reference to certain exemplary embodiments thereof, it will be understood by those skilled in the art that various changes in form and details may be made therein without departing from the spirit and scope of the invention as defined by the appended claims.

1. A digital communication system, comprising:
a preamble symbol obtaining unit for obtaining preamble symbols respectively corresponding to a plurality of cells or sectors from a baseband frequency signal;
a signal estimation unit for estimating a preamble signal and a data signal from each preamble symbol;
a power calculation unit for, with respect to each cell or sector, calculating a power value of the estimated data signal and a power value of a noise signal from the preamble symbol and the estimated preamble signal;
a carrier-to-interference-and-noise ratio (CINR) calculation unit for, with respect to each cell or sector, calculating a CINR using the power values of the data signal and the noise signal; and
a handover determination unit for comparing the CINRs with each other and determining whether to perform handover or not.

2. A digital communication system, comprising:
a preamble symbol obtaining unit for obtaining preamble symbols from a baseband frequency signal;
a signal estimation unit for estimating preamble signals and data signals from the preamble symbols;
a power calculation unit for calculating power values of noise signals from the preamble symbols and the estimated preamble signals and calculating power values of the estimated data signals;
a CINR calculation unit for calculating a CINR using the power values of the data signals and the noise signals; and
a transmission power control unit for generating transmission power based on the CINR.

3. A digital communication system, comprising:
a preamble symbol obtaining unit for obtaining preamble symbols from a baseband frequency signal;
a signal estimation unit for estimating preamble signals and data signals from the preamble symbols;
a power calculation unit for calculating power values of noise signals from the preamble symbols and the estimated preamble signals and calculating power values of the estimated data signals;
a CINR calculation unit for calculating a CINR using the power values of the data signals and the noise signals; and
a CINR reporting unit for transmitting the CINR to a base station.

4. The digital communication system of claim 1, wherein the preamble signal obtaining unit obtains the preamble symbols respectively corresponding to the cells or sectors from one fast Fourier transform (FFT) device by time-division.

5. The digital communication system of claim 1, wherein the baseband frequency signal is an orthogonal frequency division multiplexing (OFDM) signal or orthogonal frequency division multiple access (OFDMA) signal.

6. The digital communication system of claim 1, wherein the signal estimation unit comprises:
an interpolation operation unit for performing an interpolation operation on the preamble signals in a frequency domain and generating a virtual preamble symbol set; and
an average operation unit for performing an averaging operation on the virtual preamble symbol set and estimating the preamble signals.

7. The digital communication system of claim 1, wherein the signal estimation unit comprises:
a gain mapping unit for adjusting gain of the estimated preamble signals and estimating the data signals.

8. The digital communication system of claim 1, wherein when a frequency reuse factor is 1, the power calculation unit further includes power values of symbols at positions where the preamble symbols are not transmitted for calculating the power values of the noise signals.

9. The digital communication system of claim 3, wherein the base station adjusts a wireless resource factor using the reported CINR.

10. The digital communication system of claim 9, wherein the wireless resource factor includes at least one of a modulation scheme, a coding scheme, a code type, and a coding rate.

11. The digital communication system of claim 1, wherein the system is based on at least one of Institute of Electrical and Electronics Engineers (IEEE) 802.16d/e standards, wireless broadband Internet (WiBro), and worldwide interoperability for microwave access (WiMAX).

12. A digital communication system, comprising:
a preamble symbol obtaining unit for obtaining preamble symbols respectively corresponding to a plurality of cells or sectors from a baseband frequency signal;
a signal estimation unit for estimating a preamble signal and a data signal from each preamble symbol;
a power calculation unit for, with respect to each cell or sector, calculating a first power value of the estimated data signal and calculating a second power value of a noise signal from the preamble symbol and the estimated preamble signal;
a CINR calculation unit for, with respect to each cell or sector, calculating a CINR using the first and second power values; and
a handover determination unit for comparing the CINRs with each other and determining whether or not to perform handover between the cells or sectors,
wherein the power calculation unit determines whether or not to add third power values of symbols at positions where the preamble symbols are not transmitted to the second power values according to a frequency reuse factor.

13. A method of measuring a CINR, comprising the steps of:
obtaining preamble symbols respectively corresponding to a plurality of cells or sectors from a baseband frequency signal;
estimating a preamble signal and a data signal from each preamble symbol;
with respect to each cell or sector, calculating a power value of the estimated data signal and a power value of a noise signal from the preamble symbol and the estimated preamble signal;
with respect to each cell or sector, calculating a CINR using the power values of the data signal and the noise signal; and
comparing the CINRs with each other and determining whether or not to perform handover between the cells or sectors.

14. The method of claim 13, wherein in the step of obtaining preamble symbols, the preamble symbols are obtained from an output signal of one FFT device using time-division

15. The method of claim 13, wherein in the step of calculating power values of the data signal and the noise signal, power values of symbols other than the preamble symbol are further included for calculating the power values of the noise signals when a frequency reuse factor is 1.

16. A computer-readable recording medium, storing a program implementing the method according to claim 13.
